(19) United States
(12) Patent Application Publication
(10) Pub. No.: US 2023/0193839 A1
(43) Pub. Date: Jun. 22, 2023

(54) METHODS AND SYSTEMS FOR EXTENDING AN OPERATING WINDOW OF A GAS TURBINE ENGINE

(71) Applicant: Power Systems Mfg., LLC, Juipter, FL (US)

(72) Inventors: Wenping Wang, Jupiter, FL (US); Danny Grobbe, NE Elst (NL); Matthew Yaquinto, Jupiter, FL (US); Jaime Serrano, Jupiter, FL (US); Franklin van den Hout, GS Rheden (NL); Nicolas Demougeot, Jupiter, FL (US)

(21) Appl. No.: 17/554,398

(22) Filed: Dec. 17, 2021

(51) Int. Cl. F02C 9/52

(52) U.S. Cl. CPC F02C 9/52; F05D 2220/32; F05D 2270/05; F05D 2270/303; F05D 2270/44

(57) ABSTRACT

A method for extending an operating window of an operating mode of a gas turbine engine includes monitoring operating conditions of the gas turbine engine. The gas turbine engine is prevented by the method from transitioning from the first operating mode up to a second operating mode. A bulk temperature demand of the gas turbine engine is adjusted by a predefined amount to generate a first biased bulk temperature demand. The adjustment includes applying a first incremental bias to a bulk flame temperature schedule. The operation of the gas turbine engine is then adjusted based on the first biased bulk temperature demand. The monitored operating conditions are analyzed to determine whether one of the operating conditions has reached a threshold value.

### BACKGROUND

The present invention relates generally to gas turbine engines, and more particularly, to systems and methods for use in tuning gas turbine engines.

Gas turbine engines operate to produce mechanical work or thrust. The shaft of the gas turbine engine may be coupled to a generator. Mechanical energy of the shaft is used to drive a generator to supply electricity. Demand for the electricity causes a draw of electrical current from the generator, which in turn causes a load to be applied to the gas turbine engine. This load is essentially a resistance applied to the generator that the gas turbine must overcome to maintain an electrical output of the generator.

Aeroderivative DLE gas turbine engines typically progress through a series of operating modes, which are based, in part, on the load demand on the gas turbine engine. For at least some load demands, two or more operating modes overlap. Typically, DLE gas turbine engines use compressor bleed air to control the flame temperature at the pre-mixers. The lower the gas turbine engine operates in an operating mode, the higher the amount of bleed air that needs to be used, which lowers the efficiency. When the gas turbine engine needs to be operating in load demand, where a high amount of compressor air is “bled” to maintain the correct flame temperature, the gas turbine engine may be able to operate in a lower operating mode with less bleed air, which increases the efficiency of the gas turbine engine. It would thus be beneficial to expand the operating window of the lower operating modes to enlarge the region with the increased efficiency.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a method for extending an operating window of a first operating mode of a gas turbine engine is provided. The method is implemented by a processor. The method includes monitoring one or more operating conditions of the gas turbine engine. The gas turbine is operating in the first operating mode. The method also includes preventing the gas turbine engine from transitioning from the first operating mode up to a second operating mode. Furthermore, the method includes, subsequent to the preventing, adjusting a bulk temperature demand of the gas turbine engine by a predefined amount to generate a first biased bulk temperature demand. The adjusting operation includes applying a first incremental bias to a bulk flame temperature schedule. The method also includes adjusting operation of the gas turbine engine based on the first biased bulk temperature demand. Moreover, the method includes determining whether the one or more operating conditions have reached a threshold value.

In another aspect, a system for extending an operating window of a first operating mode of a gas turbine engine is provided. The system includes one or more sensors coupled to the gas turbine engine and an AutoTune controller. The one or more sensors are configured to transmit one or more operating conditions associated with the gas turbine engine to the AutoTune controller. The AutoTune controller includes a memory and a processor. The memory stores computer-executable instructions that, when executed by the processor, cause the processor to perform operations including monitoring one or more operating conditions of the gas turbine engine, wherein the gas turbine is operating in the first operating mode. Using a logic module, the processor prevents the gas turbine engine from transitioning from the first operating mode up to a second operating mode. Furthermore, subsequent to the preventing, the processor adjusts a bulk temperature demand of the gas turbine engine by a predefined amount to generate a first biased bulk temperature demand. The adjusting operation includes applying a first incremental bias to a bulk flame temperature schedule. Moreover, the processor adjusts operation of the gas turbine engine based on the first biased bulk temperature demand. In addition, the processor determines whether the one or more operating conditions have reached a threshold value.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of a tuning environment suitable for use in embodiments of the present invention;

FIG. 2 is a cross-sectional view of a triple annular combustor depicting an AB mode of operation, in accordance with one aspect of the present invention;

FIG. 3 is a cross-sectional view of the triple annular combustor depicting an ABC mode of operation;

FIG. 4 is a graph depicting an example operating window of an example operating mode of a gas turbine engine shown in FIG. 1;

FIG. 5 is a graph depicting an example expanded operating window overlayed on the operating widow of FIG. 4;

FIG. 6 is a flowchart illustrating an exemplary computer-implemented method for extending an operating window of the gas turbine engine shown in FIG. 1; and

FIG. 7 is a schematic of an example computing device that can be used for implementing aspects of the present invention.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION

The following detailed description of embodiments of the disclosure references the accompanying figures. The embodiments are intended to describe aspects of the disclosure in sufficient detail to enable those with ordinary skill in the art to practice the disclosure. The embodiments of the disclosure are illustrated by way of example and not by way of limitation. Other embodiments may be utilized, and changes may be made without departing from the scope of the claims. The following description is, therefore, not limiting. The scope of the present disclosure is defined only by the appended claims, along with the full scope of equivalents to which such claims are entitled.

Broadly, to facilitate extending an operating window of a gas turbine engine at a selected operating mode, an AutoTune controller is operable to increase a combustor bulk temperature. The combustor bulk temperature can be determined, for example, as a calculated weighted average of a total fuel flow, a total air flow, and a computed flame temperature in a combustor of the gas turbine engine. The AutoTune controller may be operable to monitor an exhaust gas temperature of the gas turbine engine. During the gas turbine engine's operation in a given burning mode, for example, an AB mode as discussed herein, the AutoTune controller may bias the combustor bulk temperature, which causes the gas turbine engine controller to modulate a fuel flow to reach a target exhaust gas temperature. The target exhaust gas temperature may be associated with and/or correspond to a biased maximum combustor bulk temperature value for the given burning mode of the combustor. Further, the AutoTune controller may monitor combustion dynamics of the gas turbine engine. Monitoring the combustion dynamics allows the AutoTune controller to maximize the expanded operating window while keeping the combustion dynamics below predetermined thresholds or limits.

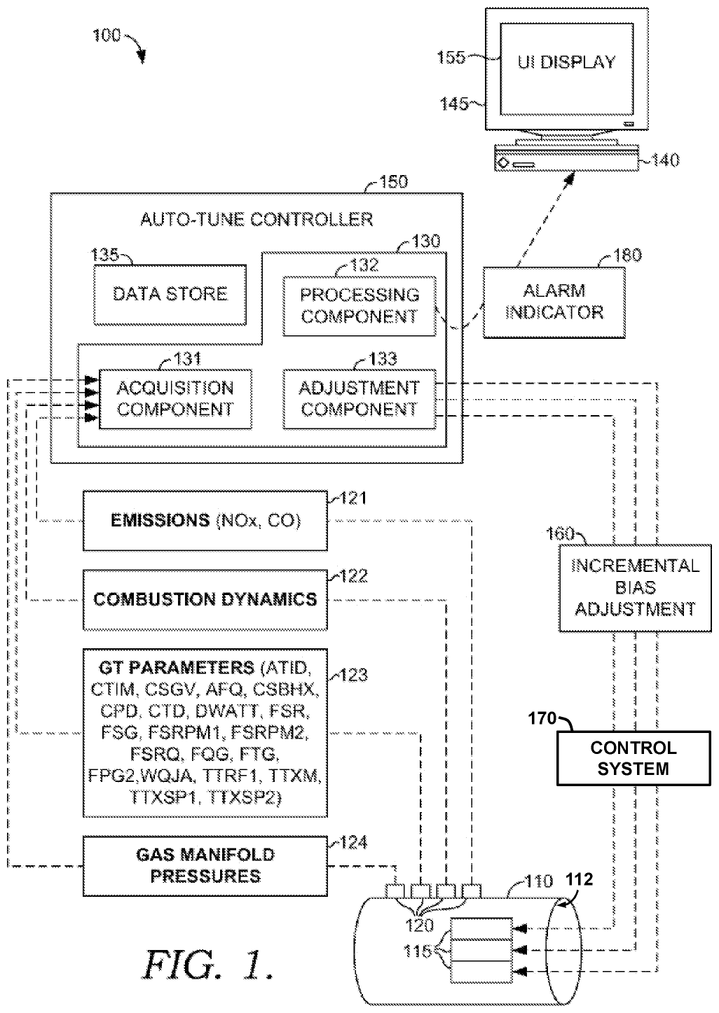

FIG. 1 is a block diagram of a tuning environment 100 suitable for use in embodiments of the present invention. The tuning environment includes a gas turbine (GT) engine 110. The gas turbine engine 110 includes a combustor 112. Generally, for the purpose of discussion, the gas turbine engine 110 may include a dry low emissions (DLE) combustor. In the exemplary embodiment, the gas turbine engine 110 includes an aeroderivative gas turbine engine such as an LM1600, LM2500, LM6000, or LMS100 aeroderivative gas turbine engine manufactured by General Electric Company of Schenectady, N.Y.

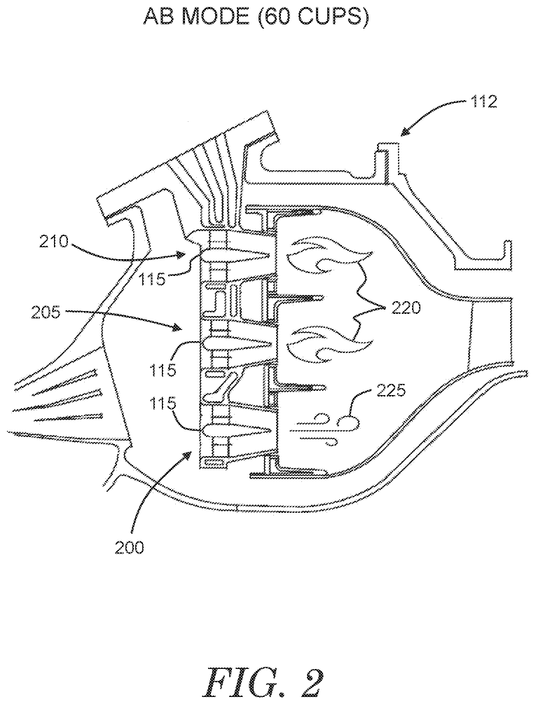

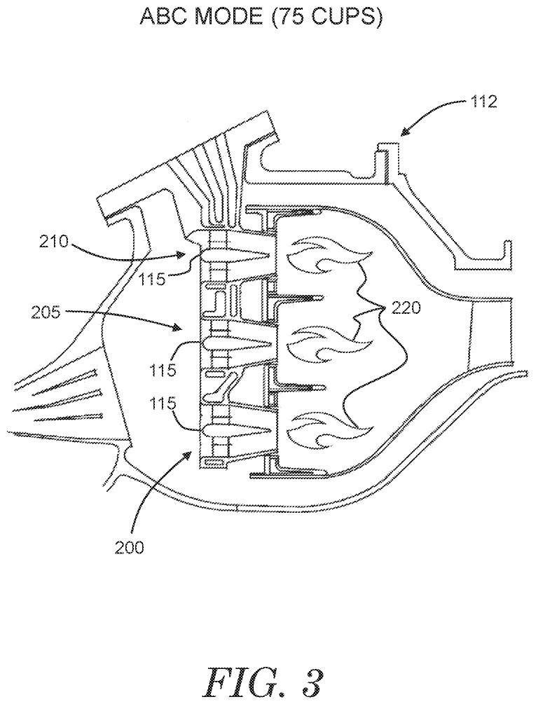

The example gas turbine engine 110 employs a triple annular combustor. The triple annular combustor includes a plurality of premixers, or cups 115 as they may be referred to, arranged in three separate rings or domes. An inner ring is referred to as the C ring 200 (shown in FIGS. 2 and 3) and includes fifteen (15) cups 115. A middle ring is referred to as the pilot or B ring 205 (shown in FIGS. 2 and 3) and includes thirty (30) cups 115. The pilot ring 205 is always fueled. An outer ring is referred to as the A ring 210 (shown in FIGS. 2 and 3), and like the pilot ring 205, includes thirty (30) cups 115. Unlike the pilot ring 205, fuel to the cups 115 in the C ring 200 and A ring 210 may be selectively turned on and off by means of one or more staging valves (not shown). Based on the type and model of gas turbine engine, there may be several different fuel circuits utilized for operating the gas turbine engine 110. Further, there may be individual fuel circuits that correspond with each of the plurality of premixers or cups 115. It should be appreciated and understood that an AutoTune controller 150, and a tuning process executed thereby, can be applied to any number of configurations of gas turbine engines and that the type or model of gas turbine engines described herein should not be construed as limiting on the scope of the present invention.

The DLE combustor 112 (i.e., dry low emissions combustor) may be prone to elevated levels of pressure fluctuation within the combustor liner. These pressure fluctuations are referred to as “combustion dynamics” 122. Left alone, combustion dynamics 122 can have a dramatic impact on the integrity and life of the combustor 112 and/or cups 115, eventually leading to catastrophic failure of the gas turbine engine 110. Combustion dynamics 122 may include, for example, one or more dynamic pressures within the combustor 112.

Further, when outside an optimal operating range, the gas turbine engine 110 may emit emissions with properties that are unacceptable (i.e., exceed a predefined threshold). In some embodiments, these properties of the gas turbine engine 110 emissions may include “emission composition” 121, which is measured periodically by a monitoring device (e.g., continuous emission monitoring system (CEMS)) (not shown). By way of example, the emission composition 121 may be measured in units of parts per million (ppm) for each of NOx and CO, while 02 may be measured in percent (%) composition. As such, emission composition 121 relates to the amount of pollutants that are generated by the gas turbine engine 110. Once the emission composition 121 is measured, it is compared against a critical (maximum/minimum) value to determine whether the emission composition 121 is actually unacceptable.

The effects of elevated combustion dynamics 121 and/or unacceptable emission compositions 121 may be mitigated or cured by adjusting a fuel flow to each of the three rings (C ring 200, pilot ring 205, and A ring 210) of the combustor 112, and more particularly, fuel flow between several groups of the operational cups 115 within the combustor 112, for example, at a given operating mode. More particularly, a control system 170 (or, in some instances, a fuel controller (not shown)) operating in the tuning environment 100 may generate and implement fuel distribution commands that affect amounts of fuel flowing to the various fuel circuits (rings) of the combustor 112. The fuel distribution commands may relate, for example, to a fuel quantity delivered for each respective fuel circuit. The fuel quantity for a respective fuel circuit may define a selected total amount of fuel delivered to the combustor 112 supplied through a particular fuel circuit.

The different fuel flows to the C ring 200, pilot ring 205, and A ring 210 are occasionally tuned to ensure that acceptable levels (conventionally low levels) of the combustion dynamics 122 are maintained while, at the same time, promoting acceptable emission compositions 121. For example, in an example embodiment, for a selected combustor bulk temperature value, increasing a percentage of the fuel flowing to the A ring 210 may increase the combustion dynamics associated with the A ring 210 and may increase the emissions associated with the pilot ring 205. Decreasing a percentage of the fuel flowing to the A ring 210 may increase the emissions associated with the A ring 210 and may increase the combustion dynamics associated with the pilot ring 205. Similarly, increasing a percentage of the fuel flowing to the C ring 200 may increase the combustion dynamics associated with the C ring 200 and may increase the emissions associated with the pilot ring 205. Decreasing a percentage of the fuel flowing to the C ring 200 may increase the emissions associated with the C ring 200 and may increase the combustion dynamics associated with the pilot ring 205.

The exemplary tuning environment 100 includes the AutoTune controller 150, a computing device 140 operably coupled to a presentation device 145 for displaying a user interface (UI) display 155, and the gas turbine engine 110. The AutoTune controller 150 includes a data store 135 (i.e., a computer-readable medium) and a processing unit 130 that supports the execution of an acquisition component 131, a processing component 132, and an adjustment component 133. Generally, the processing unit 130 is embodied as some form of a computing unit (e.g., a processor, central processing unit, microprocessor, etc.) to support operations of the component(s) 131, 132, and 133 running thereon.

In addition, the AutoTune controller 150 is provided with the data store 135. Generally, the data store 135 is configured to store information associated with the tuning process or data generated upon monitoring the gas turbine engine 110. In various embodiments, such information may include, without limitation, measurement data (e.g., measurements 121, 122, 123, and 124) provided by a plurality of sensors 120 coupled to the gas turbine engine 110. In addition, the data store 135 may be configured to be searchable for suitable access of stored information. For instance, the data store 135 may be searchable for dynamic schedules, such as a combustor bulk temperature schedule in order to determine a maximum scheduled combustor bulk temperature to increase upon comparing the measured combustion dynamics 122 to corresponding predetermined limit(s) and upon comparing the measured emissions compositions 121 to corresponding critical values, respectively. It will be understood and appreciated that the information stored in the data store 135 may be configurable and may include any information relevant to the tuning process. The content and volume of such information are not intended to limit the scope of embodiments of the present invention.

In the exemplary embodiment, the AutoTune controller 150 records one or more look-up tables (e.g., utilizing the data store 135). The look-up tables may include, for example, various information related to operating conditions of the gas turbine engine 110 and combustor 112 attached thereto. By way of example, the look-up tables may include one or more combustor bulk temperature bias values (e.g., flame temperature bias values) for applying to values in the bulk flame temperature schedule, which define an upper and lower limit of a combustor bulk temperature for a given operating mode of the gas turbine engine 110. Upon performing the process of automatically tuning the gas turbine engine 110, the AutoTune controller 150 may be automatically reprogrammed to record aspects of the tuning process in the look-up tables. That is, the combustor bulk temperature bias values in the look-up table may be written and/or altered, for example, via one or more recorded incremental bias values, to reflect occurrences during, and results from, the tuning process. Advantageously, the bias values may be accessed during a subsequent tuning procedure to facilitate making each subsequent tuning more efficient (e.g., reduce the number of fuel flow adjustment increments needed to bring a condition to a predetermine limit). In this way, the look-up table can be automatically developed through the incremental adjustment of one parameter at a time. Since the incremental adjustment is stored, for example as a bias value, in the look-up tables, the AutoTune controller 150 learns the optimum tuning performance for any particular operating mode of the gas turbine engine 110.

The control system 170 operating in the tuning environment 100 is used to assess the state of the gas turbine engine 110, the combustor 112, and the plurality of cups 115 in terms of parameters such as the combustion dynamics 122, emission compositions 121, gas turbine parameters 123, and gas manifold pressures 124. As discussed above, these parameters may be monitored by the plurality of sensors 120 to detect various operating conditions of the gas turbine engine 110 and sense various environmental parameters/conditions. For example, one or more temperature sensors may monitor an ambient air temperature at the gas turbine engine 110, a compressor discharge temperature, and an exhaust gas temperature, among various other temperatures. Pressure sensors may monitor, for example, static and dynamic pressure levels at the compressor inlet and outlet, and a gas turbine exhaust, as well as at other locations in the gas turbine engine 110.

For example, as further described herein, the plurality of sensors 120 include a first pressure sensor operable to provide a first signal (PX36A) characteristic of a dynamic pressure within the combustor 112. In addition, the plurality of sensors 120 include a second pressure sensor operable to provide a second signal (PX36B) characteristic of a dynamic pressure within the combustor 112. The multiple pressure sensors are used in the control system 28 for reliability and accuracy. The plurality of sensors 120 may also include flow sensors, speed sensors, flame detector sensors, valve position sensors, and guide vane angle sensors that sense various operational parameters of the gas turbine engine 110. In certain aspects of the present invention, one or more emission sensors may be provided to measure emission compositions 121, for example, in the exhaust gas of the gas turbine engine 110.

Based on these parameters, in the example embodiment, the bulk temperature demand is adjusted incrementally until the measured combustion dynamics 122 and/or the measured emissions compositions 121 reach predetermined thresholds or critical values. Typically, an alarm, represented schematically by alarm indicator 180, is set upon detecting that an amplitude of a pressure pulse (i.e., measured combustion dynamics 122) surpasses a predetermined upper or lower limit and/or upon recognizing that the composition of the combustor emissions has exceeded a particular critical value. Accordingly, embodiments of the present invention concern the AutoTune controller 150, as well as the associated tuning process, that enables automatic expansion of an operating window or combustor burner mode of the gas turbine engine 110, for example, by using incremental changes of a bulk temperature demand of the gas turbine engine 110 at the selected operating window or combustor burner mode while maintaining the measured emissions compositions 121 and measured combustion dynamics 122 within predetermined limits.

As used herein, the term “parameter” refers to characteristics that can be used to define the operating conditions of the gas turbine engine 110, such as temperatures, pressures, emissions, and/or fuel flows at defined locations within the gas turbine engine 110. Some parameters are measured, i.e., are sensed and are directly known, while other parameters are calculated by a model and are thus estimated and indirectly known. Some parameters may be initially input by a user to the AutoTune controller 150 and/or the control system 170. The measured, estimated, or user input parameters represent a given operating state of the gas turbine engine 110.

An overall tuning process carried out by the AutoTune controller 150 may comprise one or more of the steps described below. Initially, in one embodiment, various configurations of combustion dynamics 122 and/or emissions compositions 121 of the combustor 112 are monitored and recorded. These recorded signals may be passed through a Fourier Transform or another transformative operation, where the pressure signals (e.g., PX36A and PX36B) are converted into an amplitude versus frequency data format or spectrum. For the pressure signals, the amplitude, values, and frequencies may be compared against a predetermined upper or lower limit for, e.g., a predefined frequency band, while the emission-composition parameters may be compared against predefined critical values. The predetermined limit is generally defined in terms of pounds per square inch (psi) for a predefined frequency bands, while the critical values are defined in terms of parts per million (ppm) or percentage. However, in other instances, the predetermined limits and critical values may be expressed in other terms or units, where other types of devices are used to measure performance of the combustor 112 (e.g., accelerometers).

For a selected combustor burner mode, a logic module (not shown) is enabled, which forces the gas turbine engine 110 to stay in the selected combustor burner mode (i.e., not allowing the gas turbine engine 110 to transition to a different combustor burner mode). The logic module may be located in either the AutoTune controller 150 or the control system 170. If the logic module is located in the control system 170, then additional interface logic for communication with the AutoTune controller 150 is used to allow tuning of emissions and dynamics while the maximum bulk temperature is increased to a value that is outside of the normal combustor burner mode operating window. The control system 170 increases the power of the gas turbine engine 110, for example, by closing the bleed air valves (not shown) and increasing the fuel flow to increase power of the gas turbine engine 110 until a flame temperature percentage (T_{flame_PCT}) reaches approximately one hundred percent (100%). The exact stage up percentage can vary based on engine run parameters and load demand (also referred to herein as power demand). The T_{flame_PCT} value has a default level of ninety-five percent (95%), but is tunable in a range between and including zero percent (0%) to one hundred percent (100%). The T_{flame_PCT} value typically varies between ninety percent (90%) to one hundred percent (100%). The T_{flame_PCT} is a parameter used by the control system 170 of the gas turbine engine 110 to determine when to transition to a higher combustor burner mode (i.e., “stage up”). The T_{flame_PCT} is defined as follows:

T_{flame_PCT}=((T_{demand}−Tₘᵢₙ)/(Tₘₐₓ−Tₘᵢₙ))×100%

T_{demand} is the operating flame temperature at the selected power demand of the gas turbine engine 110. Tₘₐₓ is the maximum flame temperature (or combustor bulk temperature) allowed for the gas turbine engine 110 at the selected combustor burner mode, as determined by reference to a bulk temperature schedule for the gas turbine engine 110. Tₘᵢₘ is the minimum flame temperature (or combustor bulk temperature) allowed for the gas turbine engine 110 at the selected combustor burner mode, as determined by reference to a bulk temperature schedule for the gas turbine engine 110. As used herein, flame temperature and combustor bulk temperature are used interchangeably to refer to the average temperature within the combustor 112.

After the gas turbine engine 110 reaches a T_{flame_PCT} of one hundred percent (100%), the control system 170 maintains the T_{demand} and does not change combustor burner modes due to a permissive of the control system 170 being set to 1. The AutoTune controller 150 detects the T_{flame_PCT} as out of tune (OOT) and adds a bias value to the bulk temperature demand parameter. Namely, adding the bias value may be accomplished by the adjustment component 133 transmitting an incremental bias adjustment 160 to the control system 170 to adjust a fuel flow to at least one of the plurality of cups 115 of the combustor 112. The bias value shifts the combustor burner mode operating window by increasing the maximum combustor bulk temperature (i.e., Tₘₐₓ), which in turn reduces the T_{flame_PCT}. The control system 170 then increases T_{demand} until the T_{flame_PCT} is approximately one hundred percent (100%).

Once the single, maximum bulk temperature bias value adjustment is made, the process reiterates. That is, the steps of (a) monitoring and comparing the amplitude for a number of predetermined frequency bands to the predetermined limits, (b) increasing a power demand of the gas turbine engine 110, and (c) making an incremental adjustment to the maximum combustor bulk temperature are repeated until the monitored signal(s) reach the predetermined limit(s). As such, in instances when the monitored signal(s) is determined to reach the predetermined limit(s) or the load demand is set too high, the permissive of the control system 170 is disabled, allowing the control system 170 to stage up the gas turbine engine 110 (i.e., transition to a higher combustor burner mode; in addition to increasing the bulk temperature demand, A, B, and/or C rings can be individually incremented with the B ring typically being the incremented default).

FIG. 2 is a cross-sectional view of the triple annular combustor 112, in accordance with one aspect of the present invention. As described above, the gas turbine engine 110 is an aeroderivative gas turbine engine that employs the DLE triple annular combustor 112. More particularly, in the example embodiment, the gas turbine engine is an LM6000 GT engine. The configuration of the combustor 112 allows the gas turbine engine 110 to operate in one of several different operating modes (i.e., combustor burner modes) based, in part, on a power demand of the gas turbine engine 110 and a combustor bulk temperature of the gas turbine engine 110. Generally, the operating modes for an LM6000 gas turbine engine include the following modes, where the letter refers to the combustor ring that is turned on, or burning fuel and air: B, B-1, B-2, BC/2, BC, BC+2A, AB, AB9C, AB12C, and ABC. As a load demand on the gas turbine engine 110 increases, the control system 170 starts to close the bleed air valves (not shown). When the bleed air valves reach a maximum closed position, the flame temperature (i.e., combustor bulk temperature) increases. When the flame temperature reaches a maximum scheduled value (as defined, for example, in a combustor bulk temperature schedule), the gas turbine engine 110 transitions up to the next operating mode (i.e., stages up).

The starting configuration of the gas turbine engine 110 is one of the B, B-1, or B-2 modes. The B mode includes burning of the thirty (30) cups 115 of the pilot ring 205. The C ring 200 and A ring 210 are not fueled, but just allow air to pass therethrough.

After starting, the gas turbine engine 110 transitions to the BC/2 mode. The BC/2 mode is typically associated with an operating range of idle to about five percent (5%) load of the gas turbine engine 110. The BC/2 mode includes burning of thirty-nine (39) cups 115; thirty (30) cups 115 of the B ring 205, and nine (9) cups of the C ring 200. The remaining cups of the C ring and the entire A ring are not fueled, but just allow air to pass therethrough.

As the load demand is increased on the gas turbine engine 110, the gas turbine engine 110 transitions to the BC mode. The BC mode is typically associated with an operating range of about five percent (5%) load to about twenty-five percent (25%) load of the gas turbine engine 110. The BC mode includes burning of the forty-five (45) cups 115 of the pilot ring 205 and the C ring 200. The A ring is not fueled, but just allows air to pass therethrough.

The gas turbine engine 110 transitions to the BC+2A mode when the load demand exceeds about twenty-five percent (25%). The BC+2A mode is typically associated with an operating range of about twenty-five percent (25%) load to about thirty-five percent (35%) load of the gas turbine engine 110. The BC+2A mode includes burning of the fifty-seven (57) cups 115, including burning of the forty-five (45) cups 115 of the pilot ring 205 and the C ring 200, and twelve (12) cups 115 of the A ring 210. The remaining cups of the A ring are not fueled, but just allow air to pass therethrough.

It is noted that, in the exemplary embodiment, the B, BC/2, BC, BC+2A modes are tuned manually. The gas turbine engine 110 typically progresses through these modes transitionally during a startup process. While these modes may be tuned manually, the tuning processes described herein by the AutoTune controller 150 are nonetheless applicable to each operating mode of the gas turbine engine 110.

As the load demand is increased on the gas turbine engine 110, the gas turbine engine 110 transitions to the AB mode. The AB mode is typically associated with an operating range of about thirty-five percent (35%) load to about fifty percent (50%) load of the gas turbine engine 110. Referring to FIG. 2, the AB mode includes burning 220 of sixty (60) cups 115: the thirty (30) cups 115 of the B ring 205 and the thirty (30) cups 115 the A ring 210. The C ring is not fueled, but just allows an air flow 225 to pass therethrough.

The gas turbine engine 110 transitions to the ABC mode when the load demand exceeds about fifty percent (50%). The ABC mode is typically associated with an operating range of about fifty percent (50%) load to full load of the gas turbine engine 110. Referring to FIG. 3, the ABC mode includes burning 220 of all seventy-five (75) cups 115 of the C ring 200, pilot ring 205, and the A ring 210.

In a typical operating window of the gas turbine engine 110, the AB mode and ABC mode may have an overlapped region at certain turbine loads. That is, the AB mode and ABC mode are operating the gas turbine engine 110 at a substantially similar power demand level. Generally, at a substantially similar combustor bulk temperature, the gas turbine engine 110 operates with increased efficiency in AB mode as comparted to ABC mode. Due in part to this increased operating efficiency, an operator of the gas turbine engine 110 may desire to keep the gas turbine engine 110 in the AB mode as long as possible, for example, by extending the operating window of the AB mode.

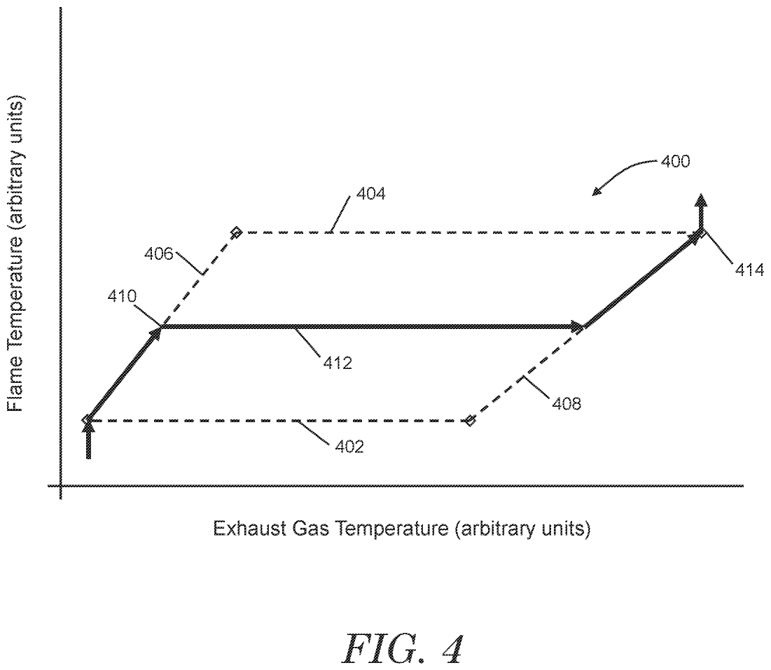

FIG. 4 is a graph that shows an example operating window 400 of an example operating mode of the gas turbine 110, such as the AB operating mode. The graph represents flame temperature versus exhaust gas temperature power of the gas turbine engine 110. Line 402 represents a minimum combustor bulk temperature value and line 404 represents a maximum combustor bulk temperature value, each of which may be defined in a bulk temperature schedule for the gas turbine engine 110. Line 406 defines a boundary of the operating window 400 where the air bleed valves reach a maximum open position. Further, line 408 defines a boundary of the operating window 400 where the air bleed valves reach a maximum closed position.

Operation of the gas turbine engine 110 in the operating mode defined by the operating window 400, based on staging up to this operating mode, begins proximate the left edge 410 of line 412. In an example where the operating mode is the AB operating mode, the control system 170 increases a fuel flow to the cups 115 of the A ring 210 and the pilot ring 205, causing the flame temperature of the combustor 112 to increase along line 412 (as indicated by the arrow), which is an average value of the minimum and maximum combustor bulk temperature values). The control system 170 continues to increase a fuel flow while substantially simultaneously increasing an air flow to the combustor 112. For example, the air bleed valves are transitioned from a maximum open position to a maximum closed position. By continuing to increase the fuel flow and the air flow to the combustor 112, the flame temperature may be maintained generally at the operational flame temperature. After the air bleed valves have reached a maximum closed position, the control system 170 continues to increase the fuel flow, thereby increasing the flame temperature along line 408, until the flame temperature reaches the maximum combustor bulk temperature value. As described above, this occurs when the T_{flame_PCT} reaches approximately ninety-five percent (95%). The gas turbine engine 110 then begins to transition to another operating mode, if available, as indicated by the vertical arrow at point 414.

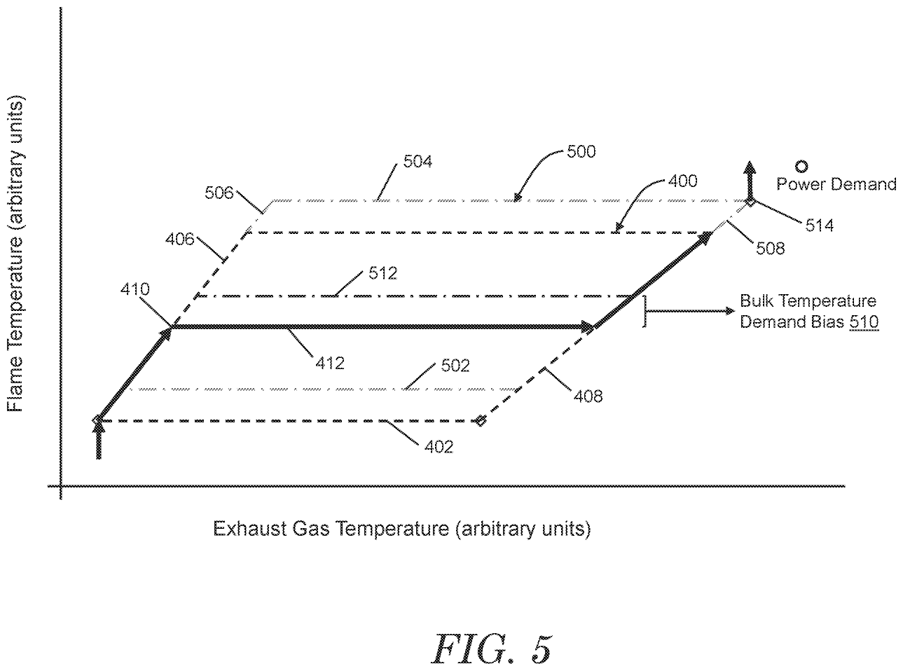

FIG. 5 is a graph that shows an example expanded operating window 500 overlayed on the operating widow 400 of FIG. 4. The graph represents flame temperature versus exhaust gas temperature power of the gas turbine engine 110. Line 502 represents a minimum biased combustor bulk temperature value and line 504 represents a maximum biased combustor bulk temperature value. Line 506 defines an extended boundary of the operating window 500 where the air bleed valves are at a maximum open position. Further, line 508 defines an extended boundary of the operating window 500 where the air bleed valves are at a maximum closed position.

In the depicted graph, the AutoTune controller 150 applies a bulk temperature demand bias 510 to the operating mode (e.g., the AB mode) defined by the operating window 400. The bulk temperature demand bias 510 sets the biased minimum and maximum combustor bulk temperature values 502, 504. Consequently, the bulk temperature demand bias 510 increases the minimum combustor bulk temperature value 402 and the maximum combustor bulk temperature value 404, each of which may be defined in a bulk temperature schedule for the gas turbine engine 110. In addition to increasing bulk temperature demand, the A or C ring temperature can be incremented in place of or along with the default B ring. Accordingly, the expanded operating window 500 includes the new biased maximum combustor bulk temperature value 504. After application of the bulk temperature demand bias 510, the control system 170 continues to increase the fuel flow to the combustor 112, thereby increasing the flame temperature along the extended boundary line 508, until the flame temperature reaches the biased maximum combustor bulk temperature value 504. As described above, this occurs when the T_{flame_PCT} reaches approximately one hundred percent (100%). The gas turbine engine 110 then begins to transition to another operating mode (e.g., ABC mode), as indicated by the vertical arrow at point 514. The transition occurs when the current operating mode (e.g., AB mode) is incapable of reaching the load demand or an operating parameter (i.e., combustion dynamics or emissions) cannot be kept within predetermined limits. The combustor burner mode hold is released if the load demand is not met after a predetermined period of time. An actual load point and ambient and/or other load indicators (such as compressor inlet temperature, electrical power, compressor discharge pressure, compressor discharge temperature, etc.) at which the combustor burner mode hold is released are stored in a look-up table for use, for example, when load decreases and the gas turbine engine 110 begins to stage down as described further below.

As load demand is decreased, the gas turbine engine 110 transitions from a first operating mode, such as the ABC mode, to a second operating mode, such as AB mode. The load point and ambient and/or other load indicators that were previously stored when the combustor burner mode hold was released are referenced from the look-up table as the point to begin a down staging transition to the second operating mode. A negative load bias of approximately negative one-half (½) megawatts (MW) is applied to this referenced power demand point to generate a transition load point to force the control system 170 to transition into the lower operating mode and ensure operating conditions such as emissions and dynamics can be maintained within acceptable limits by the AutoTune controller 150. The negative load bias can vary to accommodate operating mode limits and turbine run tendencies, but is typically in a range between and including about negative two and a half megawatts (−2.5 MW) to zero megawatts (0 MW).

### Exemplary Computer-Implemented Methods

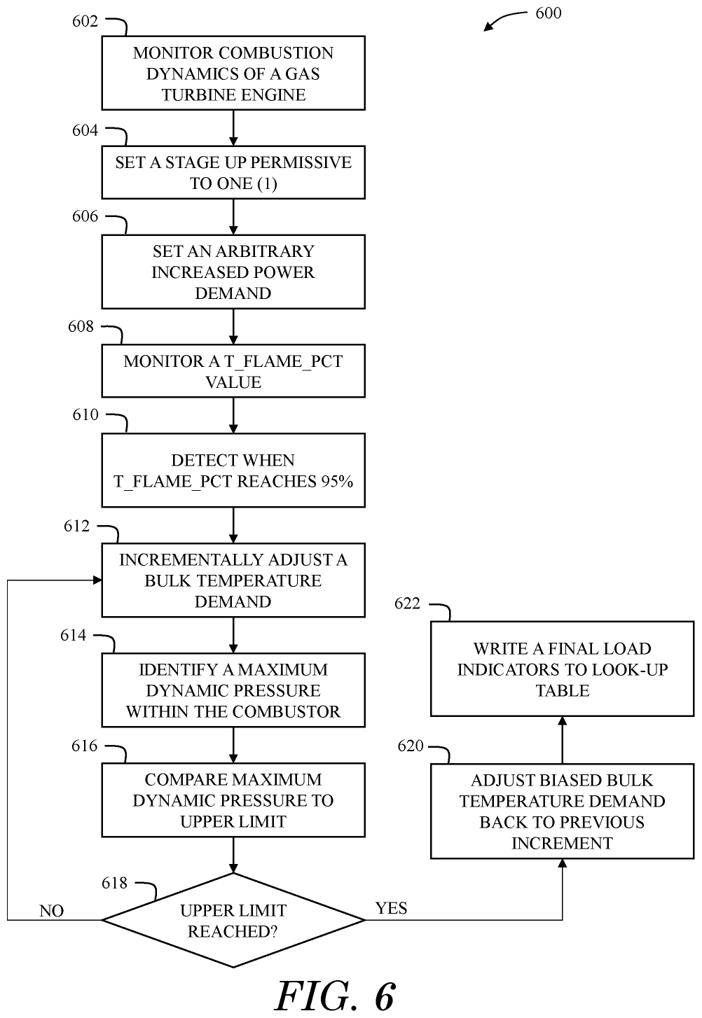

FIG. 6 is a flowchart illustrating an exemplary computer-implemented method 600 for extending an operating window of a gas turbine engine, such as the gas turbine engine 110 (shown in FIG. 1). The operations described herein may be performed in the order shown in FIG. 6 or may be performed in a different order. Furthermore, some operations may be performed concurrently as opposed to sequentially. In addition, some operations may be optional.

The computer-implemented method 600 is described below, for ease of reference, as being executed by the exemplary devices and components introduced with the embodiments illustrated in FIGS. 1-5. In one embodiment, the method 600 may be implemented by the AutoTune controller 150 (shown in FIG. 1). In the exemplary embodiment, the method 600 relates to increasing a maximum combustor bulk temperature of the gas turbine engine 110 in a selected operating mode, with monitoring and maintaining combustion dynamics of the gas turbine engine 110 with predetermined limits. While operations within the method 600 are described below regarding the AutoTune controller 150, the method 600 may be implemented on other such computing devices and/or systems through the utilization of processors, transceivers, hardware, software, firmware, or combinations thereof. However, a person having ordinary skill will appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

At operation 602, the method 400 includes substantially continuously monitoring data that represents the combustion dynamics 122 of the gas turbine engine 110. As discussed herein, in one embodiment, the combustion dynamics 122 are measured for the combustor 112 using the sensors 120 (e.g., pressure transducers) that communicate the measurement data to the acquisition component 131, for example, as pressure signals PX36A and PX36B. In another embodiment, the sensors 120 communicate emissions 121 that are detected from the gas turbine engine 110. In yet other embodiments, the measurement data collected from the gas turbine engine 110 may include, but is not limited to, gas turbine parameters 123 and gas manifold pressures 124.

In certain aspects of the present invention, the data collected from the gas turbine engine 110 is normalized. For instance, the sensors 120 (e.g., the first and second pressure sensors described above) may be configured as pressure transducers that detect pressure fluctuations in the combustor 111 and report the fluctuations as the combustion dynamics 122. The fluctuations may be measured over a predetermined time period and transmitted to the acquisition component 131 in the form of a rolling average of pressure variability.

At operation 604, a stage up permissive is set to one (1) to force the gas turbine engine 110 to stay in its current operating mode (e.g., combustor burner mode). The stage up permissive may be used, for example, by the control system 170 to ensure a specific operating state of the gas turbine engine 110 prior to staging up to a different operating mode (e.g., staging up from AB mode to ABC mode). A non-limiting example of the stage up permissive may include: a bleed air valve position; a T_{flame_PCT} value; a fuel flow; a power demand value; or the like. Generally, if the stage up permissive is satisfied (i.e., has a value of zero (0)), the control system 170 automatically stages up the gas turbine engine 110.

At operation 606, an arbitrary increased power demand is set, which is outside of the combustor burner mode operating window (i.e., a power demand that cannot be reached), such as operating window 400 (shown in FIGS. 4 & 5). The increased power demand causes the control system 170 to increase the power of the gas turbine engine 110, for example, by modulating the air and fuel flow to the combustor 112. For example, in certain embodiments, the control system 170 will close the bleed air valves to a maximum allowed point and increase fuel flow to the combustor 112 until the T_{flame_PCT} value reaches approximately ninety-five percent (95%), based in part on the bulk flame temperature schedule.

At operation 608, the AutoTune controller 150 monitors the T_{flame_PCT} value. For example, in one embodiment, the T_{flame_PCT} value may be received by AutoTune controller 150 from the control system 170. In another embodiment, the AutoTune controller 150 may determine the T_{flame_PCT} based, in part, on the bulk flame temperature schedule and the monitored combustor bulk temperature or flame temperature. At operation 610, when the T_{flame_PCT} value reaches ninety-five (95%) a logic module is enabled to set a permissive to one (1). Typically, when the T_{flame_PCT} value reaches ninety-five (95%) the control system will stage up the gas turbine engine. However, because the stage up permissive is set to one (1), the control system 170 keeps the gas turbine engine 110 at the operating condition limit of the operating window 400.

At operation 612, a bulk temperature demand of the gas turbine engine 110 is incrementally adjusted. The bulk temperature demand is determined from the bulk flame temperature schedule, based on the ambient conditions of the gas turbine engine 110 and the selected operating mode. The bulk temperature demand is incrementally adjusted by a predefined amount. Incrementally adjusting the bulk temperature demand may be accomplished by the adjustment component 133 (shown in FIG. 1) transmitting an incremental bias adjustment value 160 to the control system 170. The biased bulk temperature demand causes an increase in the scheduled maximum combustor bulk temperature value, which reduces the T_{flame_PCT} value. It is noted that the predefined amount is typically based on testing experience and the specific gas turbine engine 110 identity. Based on the biased bulk temperature demand, the operation of the gas turbine engine 110 is adjusted. For example, the control system 170 adjusts a fuel flow to at least one of the plurality of cups 115 of the combustor 112 based on the biased bulk temperature demand. Accordingly, by incrementing a fuel flow upwards or downwards, the combustor bulk temperature is altered. In one embodiment, automatic valves on the combustor 112 and/or cups 115 adjust the fuel flow for a respective fuel circuit in response to recognizing the incoming incremental bias adjustment value 160.

At operation 614, the AutoTune controller 150 identifies a maximum dynamic pressure (i.e., combustion dynamics 122) within the combustor 112, for example, from the monitored combustion dynamics 122. For example, the AutoTune controller 150 identifies the maximum dynamic pressures from the pressure signals PX36A and PX36B. At operation 616, the identified maximum dynamic pressures are compared to the predetermined upper limits (i.e., alarm limit levels). The predetermined upper limit may be based on a type of measured data being evaluated.

Upon the comparison, a determination of whether the maximum dynamic pressures exceed the predetermined upper limits is performed at operation 618. If the maximum dynamic pressures do not exceed the predetermined upper limit, such that the gas turbine engine 110 is operating within a suggested range with respect to the particular measured data, the method 600 returns to operation 612 and further incrementally adjust the bulk temperature demand. The method 600 iterates between operations 612 and 618 until one or more of the pressure signals PX36A and PX36B indicate that a maximum dynamic pressure in the combustor 112 has reached its predetermined upper limit.

If, however, one or more of the maximum dynamic pressures reach or exceed a respective predetermined upper limit, or the current operating mode is incapable of reaching the load demand, at operation 620, the AutoTune controller 150 may adjust the biased bulk temperature demand back to the previous increment where the maximum dynamic pressures did not exceed the predetermined upper limits. The AutoTune controller 150 may set the T_{flame_PCT} value to ninety-five percent (95%), based on the biased bulk temperature demand, which allows for a margin of safety associated with the biased operating window.

At operation 622, the AutoTune controller 150 and/or system controller 170 may write load indicators such as a maximum load achieved, an ambient condition, and/or other load indicators to the look-up tables, such as a load indicator look-up table. Thus, when running the gas turbine engine 110 at a future time, the load indicator look-up table may be used to extend the operating window of the gas turbine engine 110 at the selected operating mode. It is noted that in certain aspects of the present invention, because the method 400 includes substantially continuously monitoring data that represents the combustion dynamics 122 of the GT engine 110, if the combustion dynamics 122 reach a predetermined upper limit, the AutoTune controller 150 and/or system controller 170 may adjust the biased bulk temperature demand back the predetermined amount described above, and overwrite the final load indicator(s) in the associated load indicator look-up table with the new value. As such, the method 400 allows an extended operating window of a selected operating mode of the gas turbine engine 110 while maintaining the combustion dynamics 122 within specified limits.

### Example Computing Systems

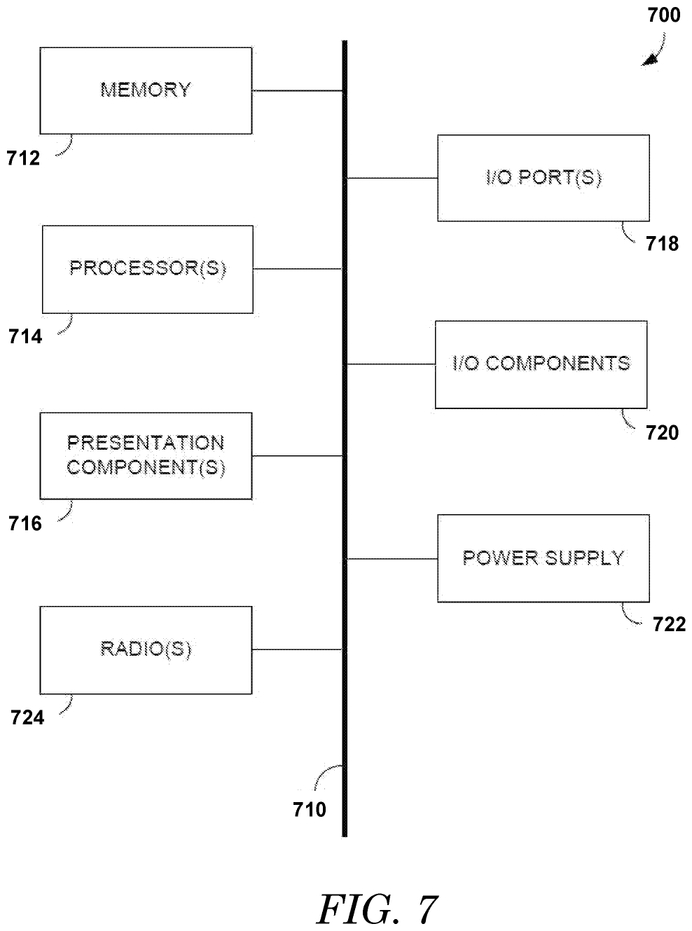

Referring now to FIG. 7, an exemplary operating environment which can be used for implementing embodiments described herein is shown and designated generally as computing device 700. Computing device 700 is but one example of a suitable computing environment and is not intended to suggest any limitation as to the scope of use or functionality of the invention. The computing device 700 should not be interpreted as having any dependency or requirement relating to any one or a combination of components illustrated.

In FIG. 7, computing device 700 includes a bus 710 that directly or indirectly couples the following devices: memory 712, one or more processors 714, one or more presentation components 716, input/output (I/O) ports 718, input/output (I/O) components 720, and an illustrative power supply 722. Bus 710 represents what may be one or more busses (such as an address bus, data bus, or a combination thereof). Although the various blocks of FIG. 7 are shown with lines for the sake of clarity, in reality, delineating various components is not as clear, and metaphorically, the lines are blurred. For example, one may consider a presentation component such as a display device to be an I/O component. Also, processors have memory. The diagram of FIG. 7 is merely illustrative of an exemplary computing device that can be used in connection with one or more embodiments of the present invention, such as the computing device 140, the AutoTune controller 150, and/or the control system 170. Distinction is not made between such categories as “workstation,” “server,” “laptop,” “hand-held device,” etc., as all are contemplated as within the scope of FIG. 7 and when referencing the “computing device.”

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that performs particular tasks or implements particular abstract data types. The invention may be practiced in any variety of system configurations, including hand-held devices, consumer electronics, general-purpose computers, and more specialty computing devices, among others. The invention may also be practiced in distributed computing environments where tasks are performed by remote-processing devices that are linked through a communications network.

Computing device 700 may include a variety of computer-readable media and/or computer storage media. Computer-readable media may be any available media that can be accessed by computing device 700 and includes both volatile and non-volatile media, removable and non-removable media. By way of example and not limitation, computer-readable media may comprise computer storage media and communication media and/or devices. Computer storage media may include volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computing device 700. These memory components can store data momentarily, temporarily, or permanently. Computer storage media does not include signals per se.

Communication media typically embodies computer-readable instructions, data structures, or program modules. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 712 includes computer storage media in the form of volatile and/or non-volatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc. I/O ports 718 allow computing device 700 to be logically coupled to other devices including I/O components 720, some of which may be built-in. Illustrative components include a microphone, joystick, game pad, satellite dish, scanner, printer, wireless device, and the like.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

Certain embodiments are described herein as including logic or a number of routines, subroutines, applications, or executable instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor or controller, may be implemented as special purpose or as general purpose. For example, the processor or controller may include a general purpose central processing unit (CPU), a graphics processing unit (GPU), a microcontroller, a reduced instruction set computer (RISC) processor, an application specific integrated circuit (ASIC), a field-programmable gate array (FPGA), a programmable logic circuit (PLC), and/or any other circuit or processor capable of executing the functions described herein. The processor or controller may also include programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor,” “processing unit,” “controller,” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor includes a general-purpose processor configured using software, the general-purpose processor may be configured as respective different processors at different times. Software may accordingly configure the processor to constitute a particular hardware configuration at one instance of time and to constitute a different hardware configuration at a different instance of time.

The methods described herein may be encoded as executable instructions embodied in a computer-readable medium, including, without limitation, a storage device, and/or a memory device. Generally, the computer-readable medium stores, at least temporarily, a plurality of computer software components that are executable by a processor. Such instructions, when executed by a processor, cause the processor to perform at least a portion of the methods described herein.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A method, implemented by a processor, for extending an operating window of a first operating mode of a gas turbine engine, said method comprising:
monitoring one or more operating conditions of the gas turbine engine, wherein the gas turbine is operating in the first operating mode;
preventing the gas turbine engine from transitioning from the first operating mode up to a second operating mode;
subsequent to the preventing, adjusting a bulk temperature demand of the gas turbine engine by a predefined amount to generate a first biased bulk temperature demand, the adjusting comprising applying a first incremental bias to a bulk flame temperature schedule;
adjusting operation of the gas turbine engine based on the first biased bulk temperature demand; and
determining whether the one or more operating conditions have reached a threshold value.

2. The method in accordance with claim 1,
said operation of preventing the gas turbine engine from transitioning from the first operating mode up to a second operating mode comprising setting a stage up permissive to one (1) to force the gas turbine engine to stay in the first operating mode.

3. The method in accordance with claim 1, further comprising setting an increased power demand for the gas turbine engine, the increased power demand being set outside of a boundary of the operating window of the first operating mode.

4. The method in accordance with claim 3, further comprising monitoring a T_{flame_PCT} value of the gas turbine engine, wherein the T_{flame_PCT} value is based on the bulk flame temperature schedule and a monitored combustor bulk temperature.

5. The method in accordance with claim 4, further comprising determining that the T_{flame_PCT} value has reached between ninety five (95%).

6. The method in accordance with claim 1, wherein the one or more operating conditions of the gas turbine engine comprises one or more of the following: combustion dynamics, emissions, and a load demand that cannot be reached.

7. The method in accordance with claim 6, wherein determining whether the one or more operating conditions have reached the threshold value comprises:
identifying a maximum dynamic pressure within the combustor from the combustion dynamics; and
comparing the identified maximum dynamic pressure to a predetermined upper limit.

8. The method in accordance with claim 1, further comprising, based on a determination that the one or more operating conditions have reached the threshold value, enabling the gas turbine engine to transition from the first operating mode up to the second operating mode.

9. The method in accordance with claim 1, further comprising:
based on a determination that the one or more operating conditions have not reached the threshold value, further adjusting the bulk temperature demand by the predefined amount to generate a second biased bulk temperature demand, the further adjusting comprising applying a second incremental bias to the bulk flame temperature schedule;
adjusting operation of the gas turbine engine based on the second biased bulk temperature demand; and
determining whether the one or more operating conditions have reached a threshold value.

10. The method in accordance with claim 9, further comprising:
based on a determination that the one or more operating conditions have reached the threshold value, adjusting the second biased bulk temperature demand back to the second biased bulk temperature demand;
writing a maximum load achieved to a look-up table; and
enabling the gas turbine engine to transition from the first operating mode up to the second operating mode.

11. The method in accordance with claim 10, further comprising:
determining that a load demand of the gas turbine engine has decreased;
recalling the maximum achieved load from the look-up table;
applying a negative load bias to the maximum achieved load to determine a transition load point;
determining that the gas turbine engine has reached the transition load point; and
transitioning the gas turbine engine from the second operating mode down to the first operating mode.

12. A system for extending an operating window of a first operating mode of a gas turbine engine, said system comprising:
one or more sensors coupled to the gas turbine engine, the one or more sensors configured to transmit one or more operating conditions associated with the gas turbine engine to an AutoTune controller; and
an AutoTune controller comprising a memory and a processor, the memory storing computer-executable instructions that, when executed by the processor, cause the processor to perform operations comprising:
monitoring one or more operating conditions of the gas turbine engine, wherein the gas turbine is operating in the first operating mode;
using a logic module, preventing the gas turbine engine from transitioning from the first operating mode up to a second operating mode;
subsequent to the preventing, adjusting a bulk temperature demand of the gas turbine engine by a predefined amount to generate a first biased bulk temperature demand, the adjusting comprising applying a first incremental bias to a bulk flame temperature schedule;
adjusting operation of the gas turbine engine based on the first biased bulk temperature demand; and
determining whether the one or more operating conditions have reached a threshold value.

13. The system in accordance with claim 12,
said operation of preventing the gas turbine engine from transitioning from the first operating mode up to a second operating mode comprises setting a stage up permissive to one (1) to force the gas turbine engine to stay in the first operating mode.

14. The system in accordance with claim 12,
said computer-executable instructions further causing the processor to perform an operation comprising setting an increased power demand for the gas turbine engine, the increased power demand being set outside of a boundary of the operating window of the first operating mode.

15. The system in accordance with claim 14,
said computer-executable instructions further causing the processor to perform an operation comprising monitoring a T_{flame_PCT} value of the gas turbine engine, wherein the T_{flame_PCT} value is based on the bulk flame temperature schedule and a monitored combustor bulk temperature.

16. The system in accordance with claim 15,
said computer-executable instructions further causing the processor to perform an operation comprising determining that the T_{flame_PCT} value has reached ninety-five percent (95%).

17. The system in accordance with claim 12, wherein the one or more operating conditions of the gas turbine engine comprises combustion dynamics, the combustion dynamics including one or more dynamic pressures within a combustor of the gas turbine engine.

18. The system in accordance with claim 17, wherein determining whether the one or more operating conditions have reached the threshold value comprises:
identifying a maximum dynamic pressure within the combustor from the monitored one or more operating conditions; and
comparing the identified maximum dynamic pressure to a predetermined upper limit.

19. The system in accordance with claim 12,
said computer-executable instructions further causing the processor to perform an operation comprising, based on a determination that the one or more operating conditions have reached the threshold value, enabling the gas turbine engine to transition from the first operating mode up to the second operating mode.

20. The system in accordance with claim 12,
said computer-executable instructions further causing the processor to perform operations comprising:
based on a determination that the one or more operating conditions have not reached the threshold value, further adjusting the bulk temperature demand by the predefined amount to generate a second biased bulk temperature demand, the further adjusting comprising applying a second incremental bias to the bulk flame temperature schedule;
adjusting operation of the gas turbine engine based on the second biased bulk temperature demand; and
determining whether the one or more operating conditions have reached a threshold value.

21. The system in accordance with claim 20,
said computer-executable instructions further causing the processor to perform operations comprising:
based on a determination that the one or more operating conditions have reached the threshold value, adjusting the second biased bulk temperature demand back to the second biased bulk temperature demand;
writing a maximum achieved load to a look-up table; and
enabling the gas turbine engine to transition from the first operating mode up to the second operating mode.

22. The system in accordance with claim 21,
said computer-executable instructions further causing the processor to perform operations comprising:
determining that a load demand of the gas turbine engine has decreased;
recalling the maximum achieved load from the look-up table;
applying a negative load bias to the maximum achieved load to determine a transition load point;
determining that the gas turbine engine has reached the transition load point; and
transitioning the gas turbine engine from the second operating mode down to the first operating mode.
